(19) United States
(12) Patent Application Publication
(10) Pub. No.: US 2026/0054693 A1
(43) Pub. Date: Feb. 26, 2026

(54) Method for Operating a Vehicle and System

(71) Applicant: Bayerische Motoren Werke Aktiengesellschaft, Muenchen (DE)

(72) Inventors: Hans AUER, Ergoldsbach (DE); Liang Chen, Muenchen (DE); Daniel Knobloch, Los Gatos, CA (US); Thorsten Knott, Tuntenhausen (DE); Daniel Kuelzer, Muenchen (DE)

(21) Appl. No.: 19/300,870

(22) Filed: Aug. 15, 2025

(30) Foreign Application Priority Data
Aug. 23, 2024 (DE) 10 2024 124 219.1

(51) Int. Cl. B60R 25/25; B60R 25/20; B60R 25/24; G10L 15/22

(52) U.S. Cl. CPC B60R 25/257; B60R 25/209; B60R 25/245; G10L 15/22; B60R 2325/101; B60R 2325/103; B60R 2325/202; B60R 2325/205; G10L 2015/223

(57) ABSTRACT

The invention relates to a method for operating a vehicle. According to forms of the invention, it is envisaged that for starting up the vehicle by means of a mobile electronic device carried by a user, the user will gain access to the vehicle by localizing the mobile electronic device by means of Bluetooth RSSI and by performing a first operating action of the user on the exterior of the vehicle. Starting the drive motor of the vehicle is carried out by a user of the mobile electronic device in the vehicle as a vehicle occupant by performing a second operating action of the user in the interior of the vehicle on the mobile electronic device and/or with the mobile electronic device.

### CROSS REFERENCE TO RELATED APPLICATION

This application claims priority under 35 U.S.C. § 119 from German Patent Application No. 10 2024 124 219.1, filed Aug. 23, 2024, the entire disclosure of which is herein expressly incorporated by reference.

### BACKGROUND AND SUMMARY

The invention relates to a method for operating a vehicle.

In vehicles with keyless entry systems, mobile electronic devices, or so-called smart devices, such as smartphones, tablet PCs or data glasses, can be used to lock or unlock vehicle doors. Access to the vehicle is therefore not by means of a key specially provided for the vehicle or a key specially assigned to the vehicle.

An antenna arrangement for the keyless use of a vehicle for this purpose is known from DE 197 52 149 A1. For keyless entry to the vehicle, bidirectional communication between an ID card and a processing device in the vehicle is envisaged. To detect whether the ID card is inside or outside the vehicle, several loop antennas are mounted on the exterior of the vehicle and one loop antenna in the interior.

Furthermore, DE 10 2011 116 157 A1 describes a method for operating an authorization system for keyless access to a vehicle and for starting a vehicle. For this purpose, a wireless communication link for the exchange of data telegrams is established between a portable ID transmitter with a motion sensor and an authorization device. Keyless entry to the vehicle is only permitted if a time of the last movement of the ID transmitter detected by the motion sensor is within a specified time interval. The authorization device allows the keyless start of the vehicle only if keyless entry to the vehicle has been previously permitted.

Finally, DE 10 2021 123 681 A1 discloses a method for controlling an access system to a vehicle in which an ID transmitter receives a request message sent by a vehicle communication unit of the vehicle for a first zone in an environment of the vehicle and in response sends a registration message to the vehicle communication unit for registration in the first zone. In addition, in response, the ID transmitter may receive a confirmation message sent by the vehicle communication unit confirming registration in the first zone.

An object of the invention is to specify a method for operating a vehicle with which, in addition to access to the vehicle, a vehicle start or motor start of the vehicle is made possible in a reliable and safe manner.

According to forms of the invention, this object is achieved by a method for operating a vehicle with the features of claim 1.

Advantageous versions of the invention are the subject of the dependent claims and the description.

With the method of operating a vehicle according to forms of the invention, access to the vehicle, starting the motor of the vehicle and locking of the vehicle are carried out in a safe and reliable manner with a mobile electronic device carried by a user and therefore not with a key specifically provided for the vehicle. In order to put the vehicle into operation with access to the vehicle and with starting the motor of the vehicle as well as for locking the vehicle, a constant data exchange between the vehicle and the electronic terminal is provided.

The user's access to the vehicle is triggered by means of a Bluetooth RSSI (RSSI-received signal strength indication) localization of the mobile electronic device and an additional action by the user that is performed as the first operating action. Bluetooth RSSI localization of the mobile electronic device determines the position of the mobile electronic device based on the (non-linear) link between signal strength or signal intensity and the distance of a communication signal between the mobile electronic device and the vehicle, in particular by means of Bluetooth technology, preferably by means of Bluetooth Low Energy Technology (BLE).

This means that when the user accesses the vehicle, the user must perform a first operating action outside the vehicle after the mobile electronic device located outside the vehicle has been localized by means of Bluetooth RSSI. This first operating action by the user, which takes place outside the vehicle, is specified in particular as the operation by the user of a control element mounted on the vehicle, preferably as the operation of a door handle of the vehicle or the operation of a tailgate of the vehicle, or as the operation of a button or switch or push button mounted on the exterior of the vehicle. Alternatively, this first operating action of the user, which takes place outside the vehicle, can also be specified as a voice input by the user to the mobile electronic device, i.e. the user must enter a specific voice command to the mobile electronic device.

When the drive motor of the vehicle is started by a vehicle occupant as the user of the mobile electronic device located in the vehicle, the user must perform a second operating action within the vehicle on the mobile electronic device now located in the interior of the vehicle and/or with the mobile electronic device now located in the interior of the vehicle.

This second operating action in the vehicle by the vehicle occupant as the user of the mobile electronic device to start the drive motor of the vehicle, which takes place within the vehicle, is specified in particular as placing the mobile electronic device in a storage point provided for this purpose in the interior of the vehicle. In this case, when the mobile electronic device is placed in the storage point, near field communication (NFC) takes place between the mobile electronic device and a control unit of the vehicle to check the mobile electronic device. If this check of the mobile electronic device has been positive, the starting process of the drive motor of the vehicle is approved.

Alternatively, this second operating action performed within the vehicle by the vehicle occupant as the user of the mobile electronic device in the vehicle for starting the drive motor of the vehicle, can be specified as a confirmation response of the vehicle occupant as the user to a message sent to the mobile electronic device located within the vehicle. In this case, the mobile electronic device is localized or positioned using Bluetooth RSSI by means of a communication between the mobile electronic device and a control unit of the vehicle using Bluetooth technology, preferably using Bluetooth Low Energy Technology (BLE). This localization of the mobile electronic device by means of Bluetooth RSSI within the vehicle is the condition for a short message to be sent to the mobile electronic device as a so-called “push notification”. This short message is then confirmed by the vehicle occupant as the user of the mobile electronic device by means of a confirmation action on the mobile electronic device. This can be done in particular by pressing a button or swiping the mobile electronic device, i.e. the second operating action of the vehicle occupant as a user of the mobile electronic device can be a tapping movement on the mobile electronic device or a swiping movement over the surface of the mobile electronic device. Alternatively, this short message can also be confirmed by facial recognition of the vehicle occupant as the user of the mobile electronic device.

The second operating action performed within the vehicle by the vehicle occupant as the user of the mobile electronic device can also be specified as a voice input by the user to the mobile electronic device, i.e. the vehicle occupant as the user of the mobile electronic device must enter a specific voice command to the mobile electronic device for this purpose.

When the vehicle is locked by a vehicle occupant as the user of the mobile electronic device leaving the vehicle, performing a third operating action by the user of the mobile electronic device is necessary. This third operating action by the user of the mobile electronic device is in particular a confirmation response of the user to a message sent to the mobile electronic device localized outside the vehicle. In this case, the mobile electronic device is localized or positioned by means of Bluetooth RSSI by means of communication between the mobile electronic device and a control unit of the vehicle. This localization of the mobile electronic device as being outside the vehicle by means of Bluetooth RSSI is the condition for a short message to be sent to the mobile electronic device as a “push notification”. This short message is then confirmed by the user of the mobile electronic device by means of a confirmation action on the mobile electronic device. This can be done in particular by pressing a button or swiping the mobile electronic device, i.e. the third operating action of the user of the mobile electronic device can be a tapping movement on the mobile electronic device or a swiping movement over the surface of the mobile electronic device.

Alternatively, this third operating action by the user of the mobile electronic device that takes place outside the vehicle can also be specified as a voice input by the user to the mobile electronic device, i.e. the user of the mobile electronic device must enter a specific voice command to the mobile electronic device after leaving the vehicle.

The mobile electronic device is in the form in particular of a smartphone, of a tablet PC, of data glasses, of a wristband, of a finger ring or of a garment of the user.

The invention also includes a system containing a mobile electronic device carried by a user (i.e. portable) and a vehicle, wherein the mobile electronic device and the vehicle are set up to carry out the steps of the method according to the invention.

The steps of the method according to the invention are processed or controlled and evaluated on the vehicle side, in particular by a control unit of the vehicle or by a controller of the vehicle and/or in the case of the electronic terminal, in particular by a microcontroller of the electronic terminal.

Further features of the invention result from the claims, the Figures, and the description of the Figures. The features and combinations of features mentioned above in the description as well as the features and combinations of features mentioned below in the description of the Figures and/or shown in the Figures alone can be used not only in the respective specified combination, but also in other combinations or individually.

The invention is now explained in more detail by means of a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic representation of a user carrying a smartphone as an electronic device when approaching the vehicle;

FIG. 2 shows a schematic representation of a vehicle occupant carrying a smartphone as an electronic device in a vehicle.

### DETAILED DESCRIPTION OF THE DRAWINGS

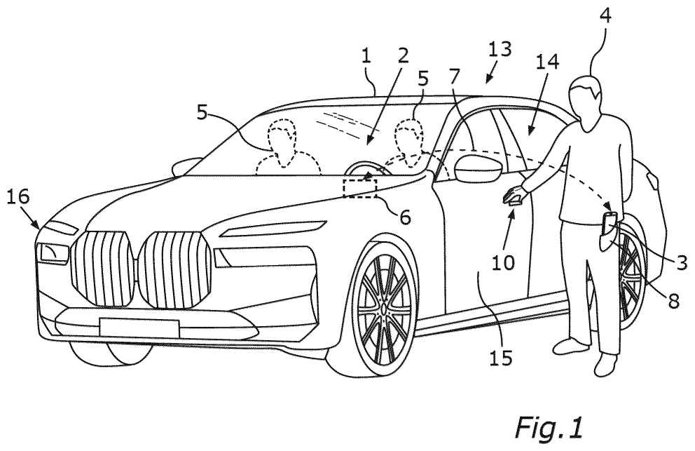

FIG. 1 shows access to a vehicle 1 by a user 4, i.e. how a user 4 as a potential vehicle occupant 5 of a vehicle 1 approaches the vehicle 1 on the driver's side 13 of the vehicle 1. The user 4 as a potential vehicle occupant 5 carries a Bluetooth-enabled mobile electronic device 3 in the form of a smartphone in his clothing, for example in a pocket 8 of his trousers. When the user 4 approaches the vehicle 1 as a potential vehicle occupant 5 of the vehicle 1, a (short-range) communication is carried out on the communication path 7 by means of Bluetooth RSSI between the smartphone 3 and a control unit in the form of a door control unit of the vehicle 1, for example, or another control unit 6 of the vehicle 1 in the interior of the vehicle 1. In this way, a specific exchange protocol is used for positioning or localization of the smartphone 3 and to check whether the smartphone 3 is located outside the vehicle 1 as an approved electronic key and is thus located on the exterior 14 of the vehicle 1 and whether the smartphone 3 is authorized or approved as an approved electronic key for starting up the vehicle 1.

If this is the case, the user 4 as a potential vehicle occupant 5 must perform a first operating action on the exterior 14 of the vehicle 1 to ensure that the smartphone 3 is actually outside the vehicle 1 as an approved electronic key. For example, the first operating action of the user 4 on the exterior 14 of the vehicle 14 as a potential vehicle occupant 5 must be the operation of a door handle 10 of a vehicle door 15. This operation of a door handle 10 of a vehicle door 15 is also monitored by the door control unit of the vehicle 1 or the other control unit 6 of the vehicle 1. If the two conditions of localizing the smartphone 3 as an approved electronic key outside the vehicle 1 and performing the first operating action of the user 4 as operating a door handle 10 of a vehicle door 15 are met, the vehicle 1 is unlocked and access to the vehicle is made possible for the user 4 as a potential vehicle occupant 5.

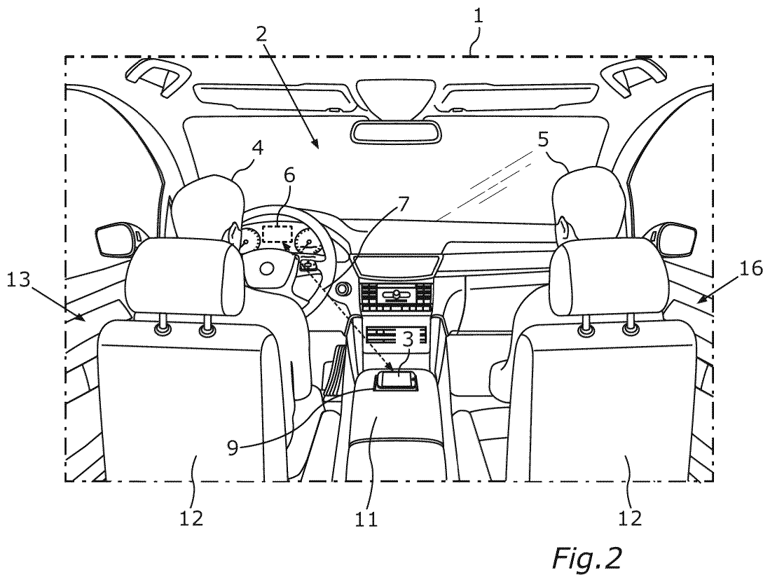

FIG. 2 shows how the user 4 sits on the driver's side 13 of the vehicle 1 in the interior 9 of the vehicle 1 after boarding the vehicle 1 as the driver of the vehicle 1 and thus as a vehicle occupant 5 of the vehicle 1. Furthermore, there is also a passenger as a vehicle occupant 5 of the vehicle 1 on the passenger side 16 of the vehicle 1 in the interior 2 of the vehicle 1. The driver of the vehicle 1 performs a second operating action as a vehicle occupant 5 by placing the smartphone 3 already used to access vehicle 1 in the storage point 9 located on the center console 11 in the interior 2 of the vehicle 1.

From the control unit 6 located in the interior 2 of the vehicle 1, a communication is carried out on the communication link 7 to the smartphone 3, which is now located in the interior 2 of the vehicle 1. For this purpose, (short-range) communication is first carried out on the communication path 7 by means of Bluetooth RSSI between the smartphone 3 and the control unit 6 of the vehicle 1 and positioning or localization of the smartphone 3 is carried out by means of a specific exchange protocol. This checks whether the smartphone 3 is present as an approved electronic key within the vehicle 1 and thus in the interior 2 of the vehicle 1. If the smartphone 3 is positively localized in the interior 2 of the vehicle 1, the control unit 6 checks whether the smartphone 3 is authorized or approved as an approved electronic key for starting up the vehicle 1. The communication between the smartphone 3 and the control unit 6 of the vehicle 1, for example, takes place as a (short-range) near-field communication (NFC). If the two conditions of localizing the smartphone 3 as an approved electronic key within the vehicle 1 and performing the second operating action as placing the smartphone 3 in the storage point 9 on the center console are met, it is possible to start the drive motor of the vehicle 1.

Likewise, when the vehicle occupant 5 leaves the vehicle 1, the vehicle 1 can be locked again using the smartphone 3. For this purpose, when the user 4 exits the car as a former vehicle occupant 5 of the vehicle 1, a (short-range) communication is carried out on the communication path 7 by means of Bluetooth RSSI between the smartphone 3 and a control unit of the vehicle 1, for example in the form of a door control unit of the vehicle 1, or the other control unit 6 of the vehicle 1. This means that a specific exchange protocol is used to position or localize the smartphone 3 and to check whether the smartphone 3 is outside the vehicle 1 again as an approved electronic key and whether the smartphone 3 is authorized or approved as an approved electronic key for locking the vehicle 1.

If this is the case, the user 4 as a former vehicle occupant 5 must perform a third operating action on the smartphone 3. For this purpose, a short message is first sent from the vehicle 1 to the smartphone 3 located outside the vehicle 1 as an approved electronic key, which must be acknowledged by the user 4 as a former vehicle occupant 5. For this purpose, the third operating action on the smartphone 3 must be performed by the user 4 as a former vehicle occupant 5, for example, by a swiping movement on the smartphone 3 or by pressing a certain button on the smartphone 3. If the two conditions of localizing the smartphone 3 as an approved electronic key outside the vehicle 1 and performing the third operating action as acknowledging the short message by the user 4 are met, the vehicle 1 is locked.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Vehicle
2 Interior of vehicle
3 Mobile electronic device (smartphone)
4 User
5 Vehicle occupant as user
6 Vehicle control unit
7 Communication path, control unit—smartphone
8 Pocket
9 Smartphone storage point
10 Vehicle exterior component/door handle
11 Center console
12 Vehicle seats
13 Driver's side
14 Exterior of the vehicle
15 Vehicle doors
16 Passenger side

What is claimed is:

1. A method for operating a vehicle for starting up the vehicle utilizing a mobile electronic device carried by a user, the method comprising:
localizing the mobile electronic device by means of Bluetooth RSSI;
performing a first operating action of the user on the exterior of the vehicle; and
starting the drive motor of the vehicle by a user of the mobile electronic device in the vehicle as a vehicle occupant by performing a second operating action of the user in the interior of the vehicle on the mobile electronic device or with the mobile electronic device.

2. The method according to claim 1, wherein:
the first operating action of the user on the exterior of the vehicle is specified as the operation of a control element mounted on the vehicle.

3. The method according to claim 1, wherein:
the first operating action of the user performed on the exterior of the vehicle is specified as the operation of at least one of a door handle of the vehicle, a tailgate of the vehicle, or a button or switch or push button mounted on the exterior of the vehicle.

4. The method according to claim 1, wherein:
the first operating action of the user on the exterior of the vehicle is specified as a voice input of the user on the mobile electronic device.

5. The method according to claim 1, wherein:
the second operating action of the vehicle occupant in the interior of the vehicle to start the drive motor of the vehicle is specified as placing the mobile electronic device in a storage point.

6. The method according to claim 5, wherein:
when the mobile electronic device is placed in the storage point, a near-field communication is carried out between the mobile electronic device and a control unit of the vehicle.

7. The method according to claim 1, wherein:
the second operating action of the vehicle occupant performed in the interior of the vehicle to start the drive motor of the vehicle is specified as a confirmation response of the vehicle occupant to a message sent to the mobile electronic device localized within the vehicle.

8. The method according to claim 1, wherein:
the second operating action of the vehicle occupant performed in the interior of the vehicle to start the drive motor of the vehicle is specified as a voice input of the user to the mobile electronic device.

9. The method according to claim 1, wherein:
the presence of a confirmation response from the user to a message sent to the mobile electronic device located on the exterior of the vehicle is specified for locking the vehicle by means of the mobile electronic device carried by a user upon leaving the vehicle.

10. The method according to claim 1, wherein:
a voice input of a user to the mobile electronic device is specified for locking the vehicle by means of the mobile electronic device carried by the user upon leaving the vehicle.

11. The method according to claim 1, wherein the electronic device is one of a smartphone, tablet PC, data glasses, wristband, finger ring or garment of the user.

12. A system containing a mobile electronic device to be carried by a user and a vehicle, wherein the mobile electronic device and the vehicle are configured to carry out the steps of a method of claim 1.
